(19) United States
(12) Patent Application Publication
(10) Pub. No.: US 2015/0375096 A1
(43) Pub. Date: Dec. 31, 2015

(54) APPARATUS AND METHOD FOR MONITORING THE PLAY AT A GAMING TABLE

(71) Applicant: TCS JOHN HUXLEY EUROPE LIMITED, London (UK)

(72) Inventors: Harley David Jackson, Wheeler Heights NSW (AU); Jared Mayberry, Macau (CN); Andrew Michael Saunders, London (GB)

(21) Appl. No.: 14/765,407

(22) PCT Filed: Jan. 31, 2014
(86) PCT No.: PCT/GB2014/000038

§ 371 Date: Aug. 3, 2015

(30) Foreign Application Priority Data
Feb. 4, 2013 (GB) 1301972.4
Sep. 19, 2013 (GB) 1316702.8

(51) Int. Cl. A63F 1/14; G07F 17/32; A63F 1/18

(52) U.S. Cl. CPC A63F 1/14; A63F 1/18; G07F 17/32

(57) ABSTRACT

There is described a method and apparatus for monitoring the play at a gaming table. The disclosed embodiment comprises a dealing shoe adapted to output signals when cards are dealt, and an input device operable by means of sensors and/or by the dealer to output signals indicating the occurrence of events during game play such as the arrival and departure of players from the table, the placing of the first bet for each game, and the resolution of the wagers to end the game. Output signals are received and stored in a memory with an associated timestamp, and analysis of the signals and their respective timestamps enables the apparatus to determine the number of players present for each game, and to calculate the number of games played, and the duration of each game. The method and apparatus are equally applicable to gaming tables which, instead of a dealing shoe, have a gaming device such as a roulette wheel, and to gaming tables where no “gaming device” is used, such as a card table using conventional playing cards only.

The present invention relates generally to apparatus and methods for monitoring gaming operations, particularly concerns monitoring gaming at live tables. The invention is applicable to card games such as Baccarat, Blackjack and poker, and may also be used in relation to table games such as craps or roulette.

The invention will be described in detail taking Baccarat as an example, and there follows a brief explanation of the game of Baccarat in order to facilitate understanding.

Baccarat is a table card game in which the players being are usually seated along a curved side of the table and a table operator or dealer is positioned at the centre of an opposite side of the table. The table may be semicircular or kidney-shaped, or may take another form.

In casino games of Baccarat, only two hands of cards are in play. The hands are referred to as the “Player” and the “Banker” hands. Players bet on which hand will have a score closer to nine.

The table is usually divided into sectors radiating out from a dealer position, one sector for each player, and in each player's sector there are three betting fields associated with the player, to reflect the three possible outcomes on which players can wager, i.e. “Player”, “Banker” and “tie”.

Each of the cards from ace to nine has a point value equal to its rank or spot value, and the remaining cards (ten, jack, queen, and king) have a point value of zero. The point value of hands in Baccarat is determined by summing modulo ten the point value of the constituent cards of the hand. Taking the total modulo ten means disregarding the first digit in any total of ten or more. For example, a hand consisting of a three and a four is worth seven (3+4=7). A hand consisting of a seven and a nine is worth six (7+9=16, the first digit being dropped as the total is higher than ten to give a total of 6). A hand consisting of a six and a four is worth zero (6+4=10, the first digit being dropped to give a total of 0). In Baccarat, there are a total of ten ranked hand totals with the highest ranked being any two or three card combination having a total (or sum modulo ten) that totals nine. The total number of cards used to obtain the total is irrelevant, and as such, a two-card total of nine has the same ranking as a three-card total of nine.

Conventional Baccarat rules do not allow for player participation or require additional decision making once the game begins, as a standard series of rules known as the tableau governs the outcome of each game. The tableau determines when a two-card total for either the player or the Banker hand must either stand or draw another card. An example of a dealing tableau is the following set of 11 rules:
i. If either the Player or the Banker hand has a total of an 8 or a 9 they both stand.
ii. If the Player hand has total of 6 or 7, the Player hand stands.
iii. If the Player hand stands with only two cards, the Banker hand is dealt a third card if the total of its first two cards is 5 or less.
iv. If the Player hand has total of 5 or less, the Player hand is dealt a third card.
v. If the Player hand gets a third card, then the Banker hand draws a third card according to the following rules:
vi. Banker hand has total of 0, 1, 2: Banker hand always draws a third card.
vii. Banker hand has total of 3: Banker hand draws if Player's Third Card is 1-2-3-4-5-6-7-9-0 (not 8)
viii. Banker hand has total of 4: Banker hand draws if Player's Third Card is 2-3-4-5-6-7
ix. Banker hand has total of 5: Banker hand draws if Player's Third Card is 4-5-6-7
x. Banker hand has total of 6: Banker hand draws if Player's Third Card is 6-7
xi. Banker hand has total of 7: Banker hand always stands.

The game starts when a player places the first wager on the table, indicating his prediction for the outcome of the next game. When all players who are going to participate in the game have placed their wagers, the dealer draws the cards from a dealing shoe to form the two hands of cards in play.

The dealer then applies the rules of the tableau to the “Player” hand, until a value is reached at which the “Player” hand must stand.

The dealer next applies the rules of the tableau to the “Banker” hand, again until a value is reached at which the “Banker” hand must stand.

The dealer then declares the result as either a win for the “Player” hand, a win for the “Banker” hand, or a tie.

The dealer collects the bets of participants who have placed wagers on losing results, and pays out winnings to participants who have placed wagers on the winning result.

The next game is started when a player places the first bet, and the sequence is then repeated.

As can be seen from the above example, the operation of the Baccarat table is thus a series of game play sequences, each starting with the “First bet” event when the first player places a wager, followed by the “First card” event when all wagers have been placed and the dealer takes the first card from the shoe, followed by the “End game” event which occurs after the two hands of cards have been processed in accordance with the dealing tableau and all of the players' wagers have been resolved.

Gaming tables at which other card games are played will similarly have a respective discrete series of operations associated with each card game, again generally starting with the “First bet” event when the first player places a wager, followed by the “First card” event when the dealer takes the first card from the shoe. In card games where each player has an individual hand and the players sequentially operate on their hands by drawing and/or discarding cards, there will be a series of events corresponding to each player reaching a point where his hand will stand, followed by the “End game” event which occurs after all the players' hands of cards and the dealer's hand, if any, have been processed, and all of the players' wagers have been resolved.

Likewise, at gaming tables where other games such as roulette are played, play progresses as a series of games each of which starts with players placing wagers on their selected numbers. A “No More Bets” event signifies the end of betting at the table, and a “Ball Launched” event occurs when a ball is launched into the rim of the roulette wheel. This may be before or after the “No More Bets” event. The ball eventually settles in a pocket in the roulette wheel, and wagers are settled depending on the particular pocket in which the ball settles. The “game” ends when all wages have been settled, and the table is again opened for the placing of wagers for the next game.

The operation of a gaming table also includes periods where play is suspended, so that for example cards may be shuffled, gaming chips replenished, or disputes as to the result of a game resolved.

In the casino environment, the time taken to complete a game at a gaming table may vary, depending on how many players are at the table and depending for example on how quickly the cards are dealt and processed, or how quickly a roulette ball can be launched and settle to determine the result of the game. The present invention provides a means by which the operation of a gaming table may be monitored.

The automatic monitoring of these events at a gaming table requires expensive modification of the playing table and installation of sensing equipment to detect movements of chips and cards on the table and to detect the operations which result in suspension of play.

The operator of a gaming table (the dealer or croupier) is occupied during all stages of the game, for example watching the actions of the players and when appropriate dealing cards from a dealing shoe, launching and retrieving a roulette ball, and collecting and distributing gaming chips. Manual monitoring and recording of all these events by the table operator is impractical, as the operator's attention must be concentrated on the events at the table in order to promote smooth play of the game.

The present invention seeks to provide a method and apparatus by which the operation of a gaming table can be monitored and recorded, using simple equipment and without imposing significant distraction on the table operator.

One aspect of the invention provides apparatus for monitoring the operation of a gaming table, the apparatus comprising manual input means operable to provide output signals, the manual input means having a plurality of inputs each operable to provide a respective output signal corresponding to a respective event in a game being played at the table, a gaming device including sensor means to detect operations of the gaming device during a game, and provide an output signal, a processor adapted to receive the signals from the manual input means and from the sensor means of the gaming device, clock means for providing timestamp data to the processor; and a memory, wherein the processor is operable to receive the signals from the manual input means and from the sensor means of the gaming device, add respective timestamp data to the signals received, store in the memory the signals and their respective associated timestamp data, and calculate, on the basis of the signals and their associated timestamp data, a time interval between the receipt of one signal and the receipt of a subsequent signal.

In one embodiment, apparatus for monitoring operation of a gaming table comprises manual input means operable by the table operator or dealer to provide output signals, a dealing shoe including sensor means to detect the dealing of a card from the dealing shoe and provide an output signal, a processor adapted to receive the signals from the manual input means and from the dealing shoe, clock means for providing timestamp data to the processor, and a memory, wherein the processor is operable to receive the signals from the manual input means and from the dealing shoe, add respective timestamp data to the signals received, and store in the memory the signals and their respective associated timestamp data. The processor is operable to calculate, on the basis of the signals and their associated timestamp data, a time interval between the receipt of one signal and the receipt of a subsequent signal.

In another embodiment, the apparatus for monitoring operation of a gaming table comprises manual input means operable by a table operator or croupier to provide output signals, a gaming device including sensor means to detect operations of or conditions in the gaming device, a processor adapted to receive the signals from the manual input means and from the sensor means of the gaming device, clock means for providing timestamp data to the processor, and a memory, wherein the processor is operable to receive the signals from the manual input means and from the sensor means of the gaming device, add respective timestamp data to the signals received, and store in the memory the signals and their respective associated timestamp data. The processor is operable to calculate, on the basis of the signals and their associated timestamp data, a time interval between the receipt of one signal and the receipt of a subsequent signal.

The gaming device may be a roulette wheel, and may include sensor means to detect operations of the roulette wheel including spinning the wheel, launching a ball on a rim of the wheel, and to detect conditions in the roulette wheel such as the ball coming to rest in a pocket of the wheel, and to provide a respective output signal. In a particular aspect, there is provided a manual input means operable to provide output signals, the manual input means having a plurality of inputs each operable to provide a respective output signal corresponding to a respective event which may take place in a game such as baccarat, blackjack poker or in a table game such as roulette.

A third aspect of the invention provides a method and apparatus for monitoring a gaming table.

The operation of the gaming table is monitored and recorded by calculating and recording the intervals between game events and/or conditions, for example events signifying the beginning and end of a game. The workload on the table operator is minimised by providing the manual input means with a respective input corresponding to each event which may take place in a game, so that the dealer has only to make a single input movement, such as a button press, to provide a signal identifying a game event.

The apparatus of the present invention thus avoids or minimises the expense of modification to the playing table or playing equipment for the game, yet provides accurate monitoring of the operation of the table without detracting from that operation.

One embodiment of the present invention provides apparatus for monitoring the operation of a gaming table, the apparatus comprising a manual input device operable by a table operator to provide signals indicative of game play events, a gaming device including an automatic sensor operable to provide signals indicative of game play events, and a table computer including the processing means and memory to store and process the data relating to game play events.

The gaming device may be a card dealing shoe or a table device such as a roulette wheel. The automatic sensor may detect cards being dealt from a dealing shoe, or may detect events relating to the movement of a ball and/or roulette wheel.

There is now described an exemplary embodiment, comprising a gaming system for monitoring play at a Baccarat table and providing statistical analysis and reports of table operation. It is to be understood that the present invention is not limited to monitoring the game of Baccarat, but is applicable to casino table games in general.

### DESCRIPTION OF THE ILLUSTRATED EMBODIMENT

An embodiment of the invention will now be described in detail with reference to the accompanying drawings, in which:

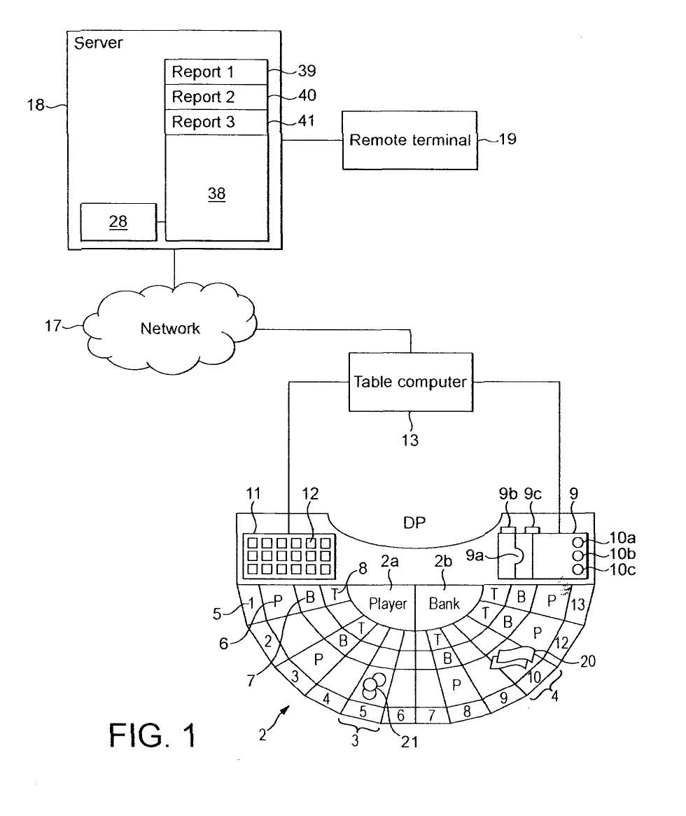

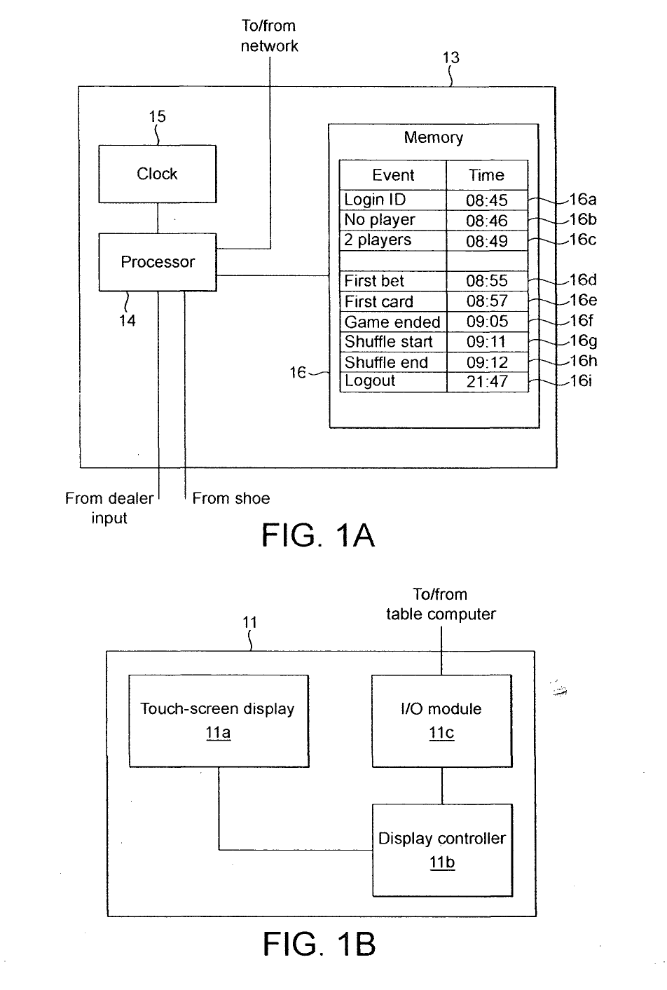

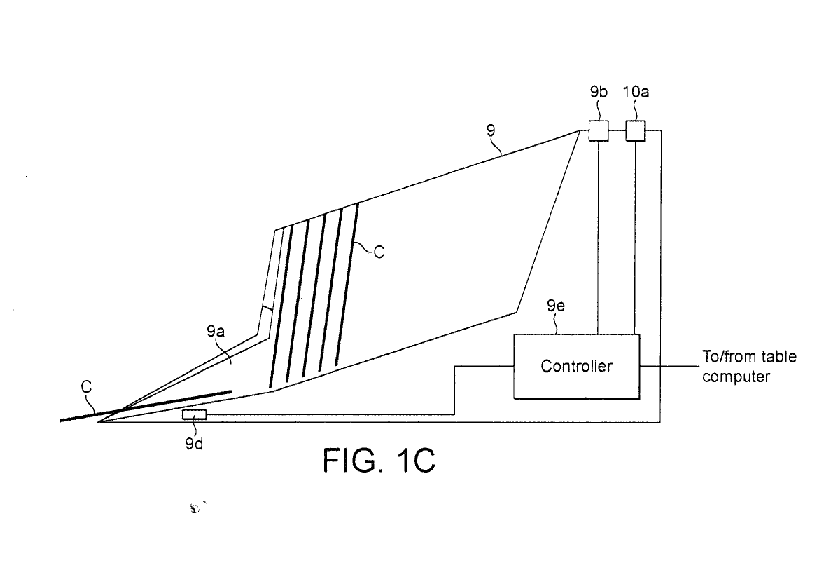

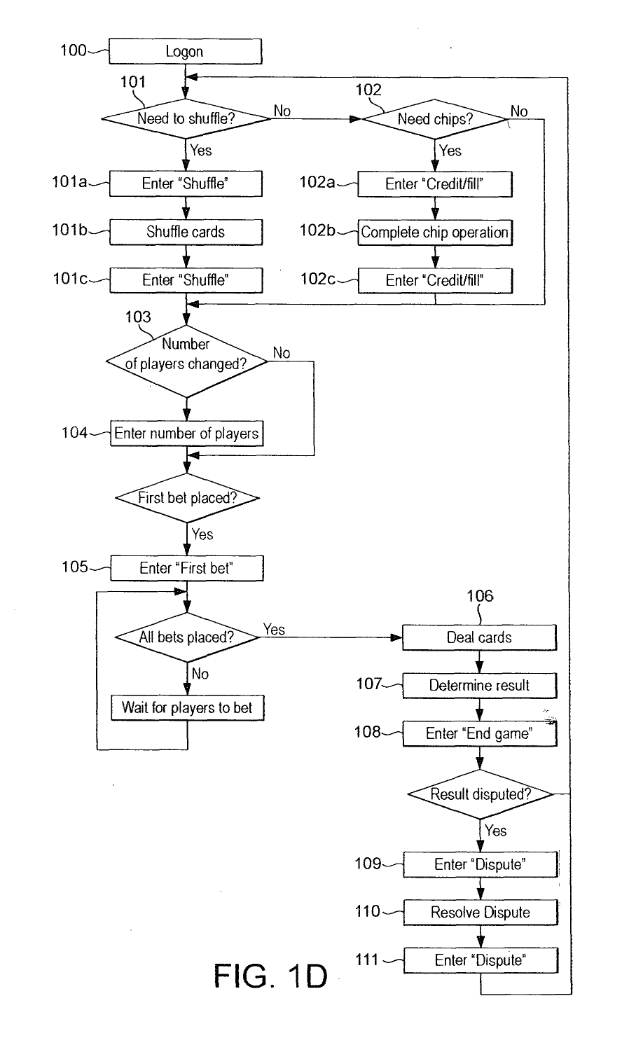

FIG. 1 is a schematic diagram of a Baccarat dealer monitoring system;

FIG. 1A is a schematic illustration of the table computer of FIG. 1;

FIG. 1B is a schematic illustration of the dealer input device of FIG. 1;

FIG. 1C is a schematic illustration of the dealing shoe of FIG. 1;

FIG. 1D is a flowchart showing the operations carried out by a dealer during play, using the monitoring system of FIGS. 1 and 1A to 1C;

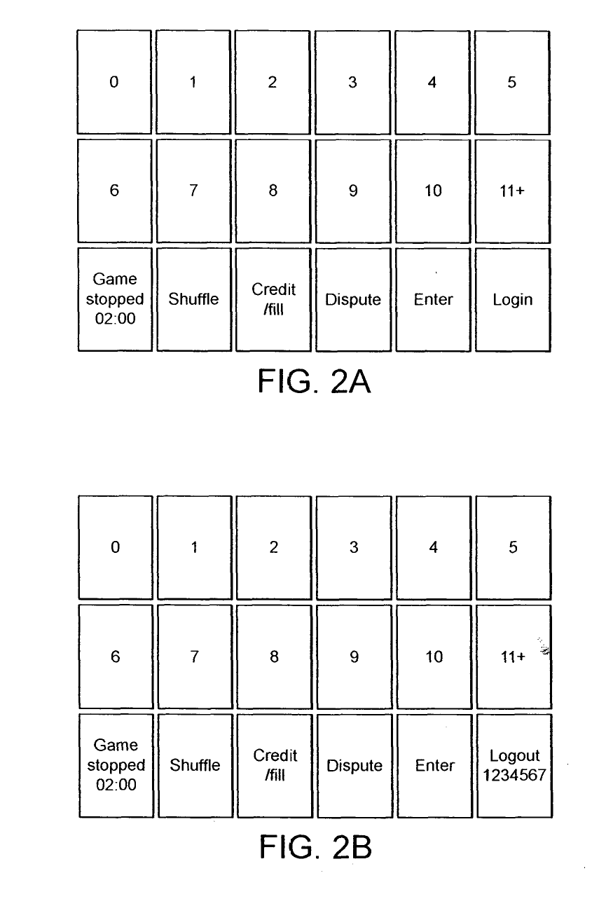

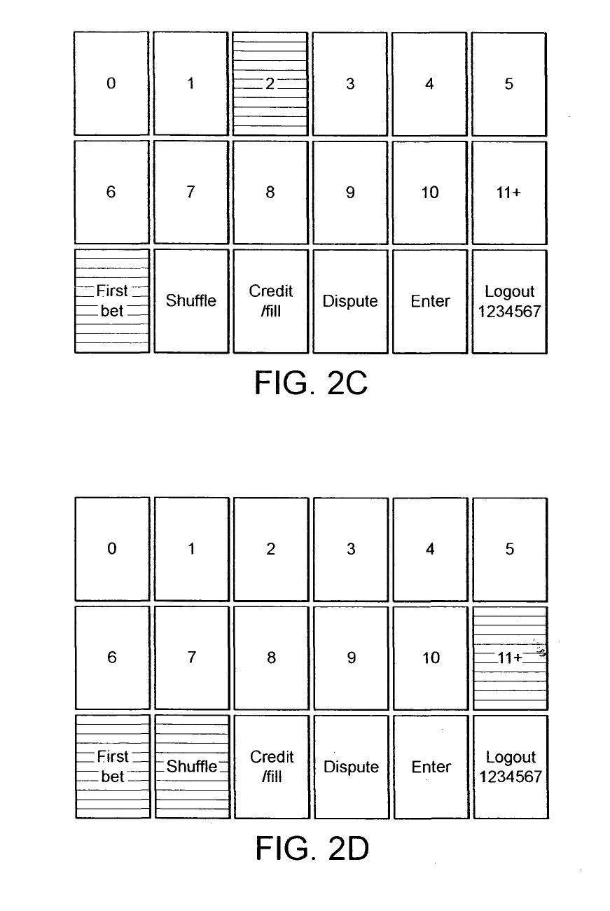

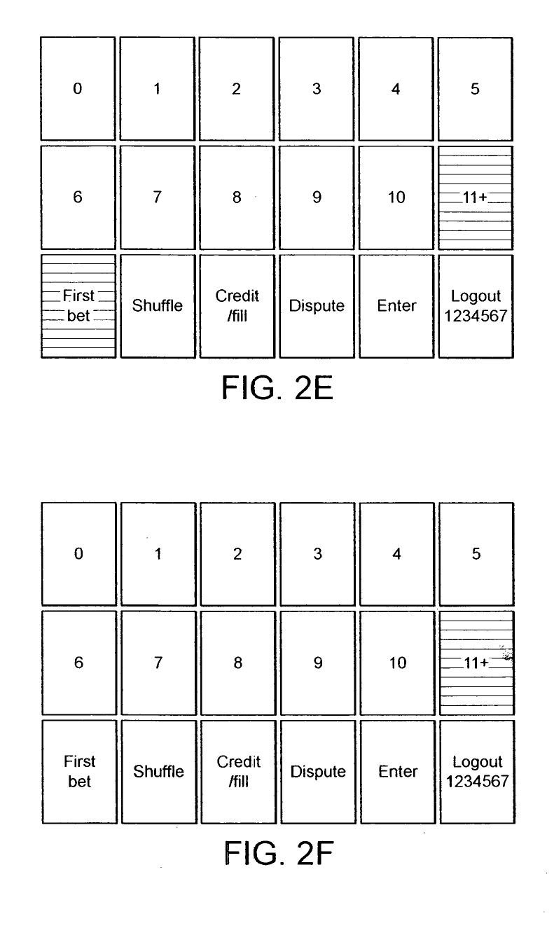

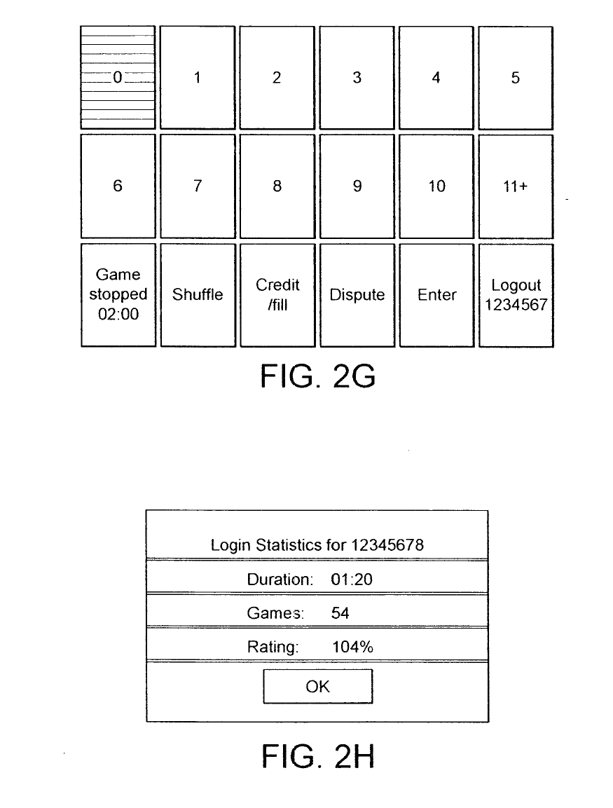

FIGS. 2A to 2H show the screen of a touch-screen dealer input device at various stages during game play;

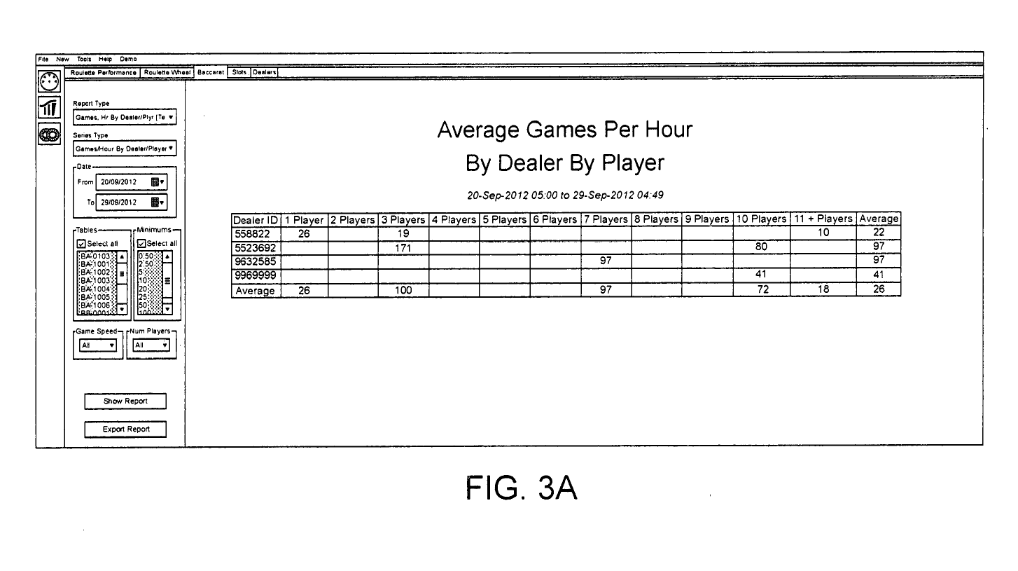

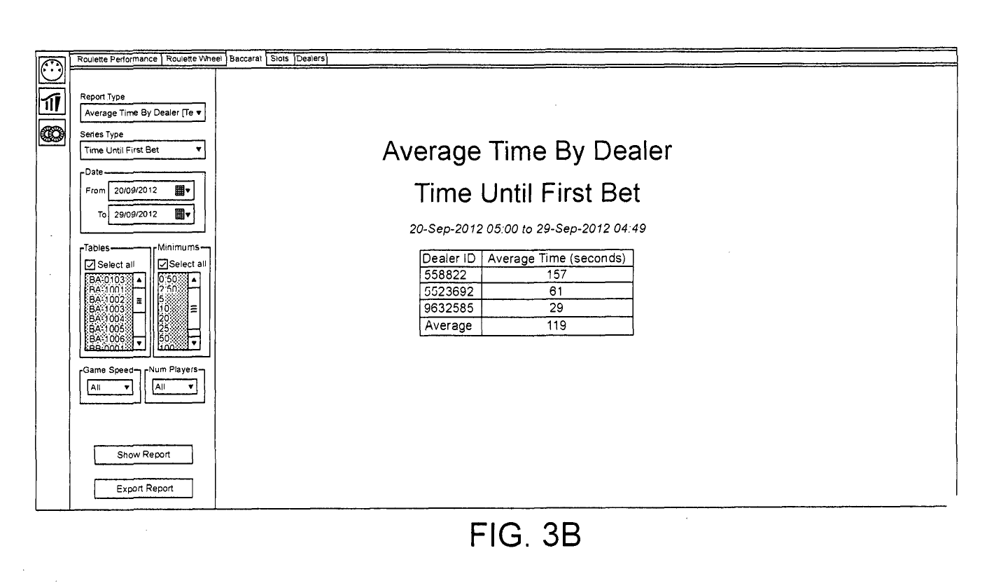

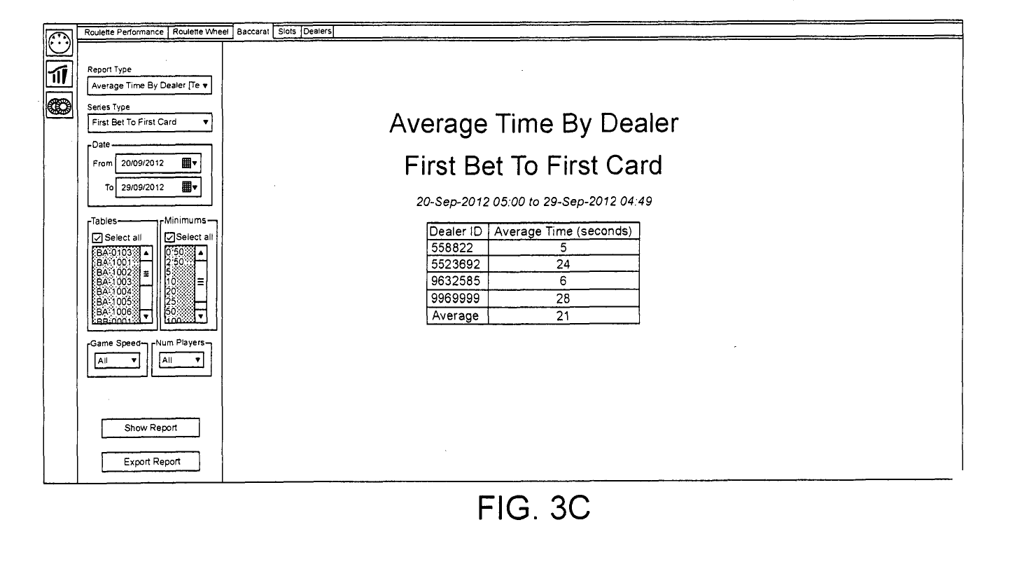

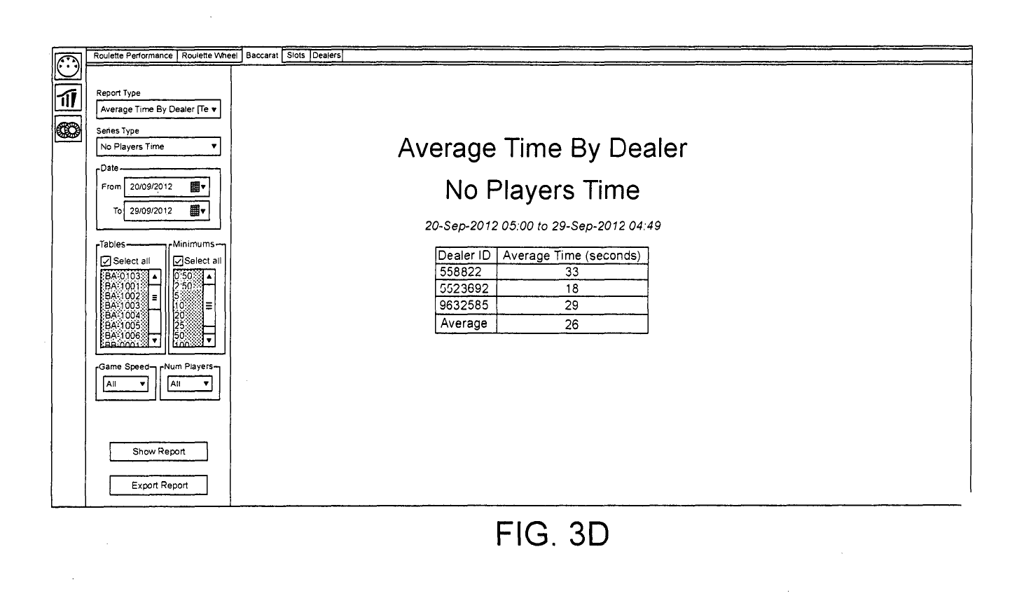

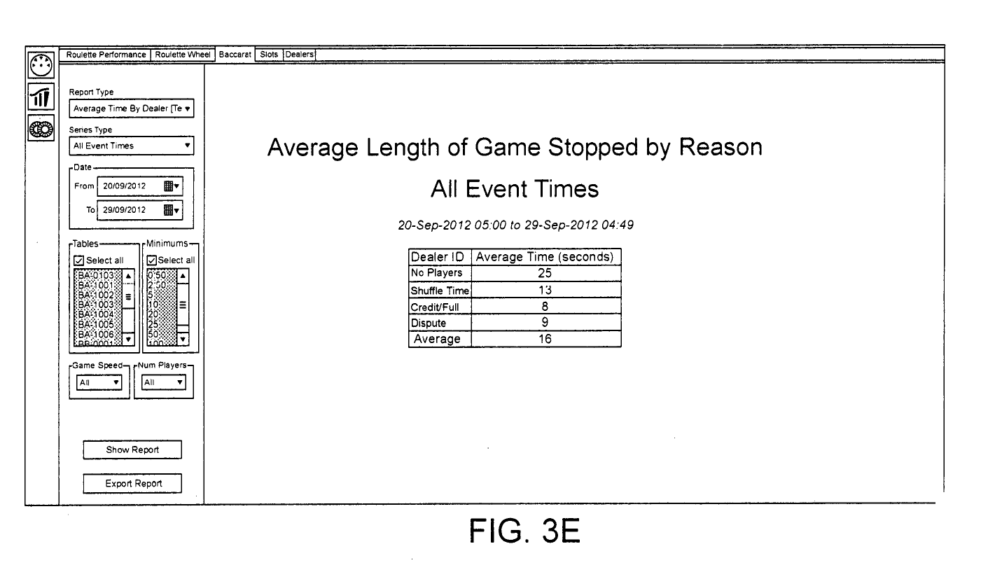

FIG. 3A to 3E show examples of reports generated and output by the apparatus concerning the operation of the baccarat table; and

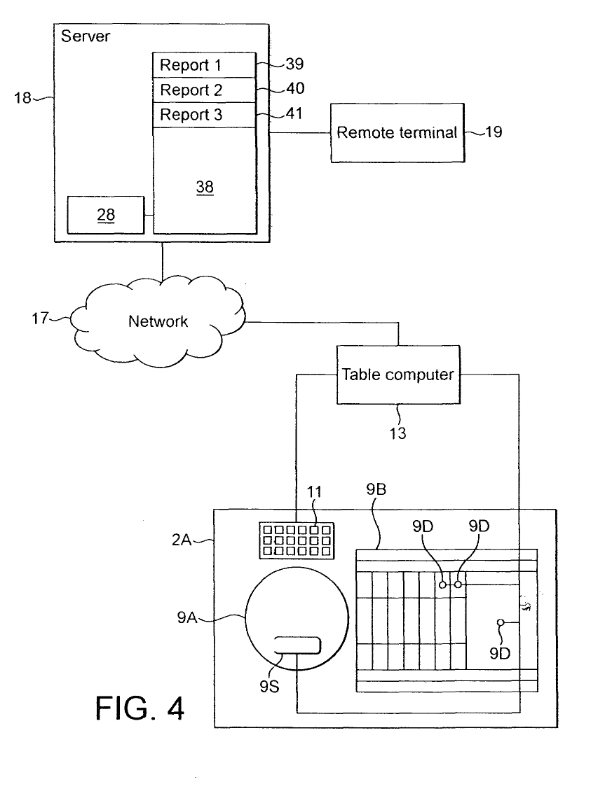

FIG. 4 is a schematic diagram similar to FIG. 1, illustrating a dealer monitoring system in use with a roulette table.

Referring now to the drawings, FIG. 1 is a schematic view of an embodiment of the system for monitoring Baccarat play in accordance with the invention.

In the illustrated embodiment, the elements of the system 1 present at the casino are a Baccarat table 2, a dealing shoe 9 situated on the table, a dealer input device 11 also on the table 2, and a table computer 13 to which the shoe 9 and the input device 11 are linked.

The illustrated Baccarat table 2 is of semicircular form, having a dealer position DP at approximately the centre, and a number of player positions 3, 4, arranged as sectors of the semicircle. Each player position has an identifying number 5 and three betting fields 6, 7, 8 corresponding to the 3 possible outcomes of each hand. Nearest to the player is betting field 6 which corresponds to the outcome “Player”. Nearest to the dealer is betting field 8, which corresponds to the outcome “tie”. Between betting fields 6 and 8 is the central betting field 7, corresponding to the outcome “Banker”. In front of the dealer position DP is a dealing area into which cards from the shoe 9 are placed to form the hands of each game. The dealing area has a region 2a to receive the cards of the “Player” hand and a region 2b to receive those of the “Banker” hand.

The dealing shoe 9 is placed adjacent the dealer position DP, the dealing shoe 9 having a chamber for storing a plurality of playing cards C, and a delivery chute 9a from which the dealer can sequentially take cards C to form the “Player” and “Banker” hands as required. The dealing shoe 9 is shown in more detail in FIG. 1C, and is provided with input buttons 9b and 9c, and indicator lights 10a, 10b and 10c, linked to a controller 9e operable to provide output signals to the table computer 13. The dealing shoe 9 is provided with a detector means 9d for detecting the removal of cards from the shoe via the delivery chute 9a, also linked to the controller 9e which is arranged to send a “First card” signal from the shoe 9 to the table computer 13 when the passage of the first card of a deal is detected.

The dealer input device is also placed adjacent to the dealer position DP, and in this embodiment is a touch-screen device which displays images of control buttons 12 which the dealer can operate by touching the screen. The arrangement, colouring and functionality of the control buttons image on the screen may change during various phases of play. FIG. 1B shows a schematic view of an embodiment of the dealer input device 11. The device comprises a touch-screen display 11a, a display controller 11b to determine the image displayed on the touch-screen 11a and to receive and identify inputs from the touch-screen, and an input/output module 11c to provide communication to and from the dealer input device 11. An important feature to note in the input device 11 is that, for each event which may occur during play, there is a dedicated input button which requires a single operation by the dealer to signal the occurrence of that event.

The dealer input device 11 and the dealing shoe 9 are linked to the table computer 13, either by a hard wired connection or by a wireless connection such as a “Bluetooth”® wireless link. Dealer inputs from the dealer input device 11 are relayed to the table computer 13 via the input/output module 11c of the dealer input device 11, as are outputs from the dealing shoe 9.

The table computer 13 in this embodiment includes a processor 14 to receive inputs from the dealer input device 11 and from the dealing shoe 9, and a clock device 15 which provides a record of the current time. When an input is received from the dealer input device 11 or from the shoe 9, the processor 14 identifies the nature of the input, adds to it a timestamp based on the current time retrieved from the clock 15, and stores the result in a memory 16. In the example shown in FIG. 1A, the processor 14 has received an input from the dealer input device 11 corresponding to a dealer login identification, has added to that information a timestamp of 08:45, and has stored the event and its associated timestamp in the memory 16. The table computer 13 is linked via a network 17 to a server 18, and an output device such as a remote terminal 19 with a monitor or printer is also linked to the server 18 for the production and outputting of statistical reports based on the gathered data.

Operation of the system will now be described.

When there is no dealer present at the table, the touch-screen of the dealer input device 11 displays the array of control buttons shown in FIG. 2A. A dealer opening the table for play presses the “Login” button on the screen, and then using the number buttons from 0 to 9 as appropriate, enters his unique identification number. The dealer then presses “Enter” to complete his login routine. When the dealer completes the login routine, the dealer input device 11 outputs to the table computer 13 a signal indicating that a dealer has logged in, and indicating his identification number. The processor 14 of the table computer 13 then retrieves the current time from the clock means 15, adds a timestamp to the signal and stores the signal in memory so as to record at 16a the login identity of the dealer and the time that he logged in to the table.

The touch-screen display then changes to the configuration shown in FIG. 2B. In this display, the lower right-hand button has changed to a “logout” button indicating the dealer's identification number so as to show which dealer is currently in charge of the table. The button may also change its appearance, for example by changing colour from red to green, to clearly indicate that a dealer is logged on.

The dealer then enters a number corresponding to the number of players presently at the table. If no players are present, the dealer enters “0” on the numerical display, and a signal is sent to the table computer 13 to indicate that no players are present. The “0” button on the display may change colour or appearance, for example by flashing, to show that the dealer has indicated no players being present. The system may be set up so that when the dealer logs in the screen automatically flashes the “0” button as a cue to the dealer. It is important to note that on the input device there is an individual number button for each number from 0 to 9, but there is also an individual number button for the number 10 and a button for “11+” to signify that 11 or more players are present at the table. It is foreseen that separate number buttons for the numbers 10, 11 and 12 may be provided on the input device, rather than only buttons for 10 and 11+. This enables the dealer to signify the presence of 10, 11 or 12 players with only a single press of a button on the touch screen, thus minimising the extra work required by the dealer to enter the monitoring information. The input device illustrated in FIG. 2 is appropriate for a baccarat table with 12 or more player positions. When the input device is to be used with a table having only 8 player positions, for example, the input device need only have the conventional number keys from 0 to 9 (the 9 key being provided to enable the dealer's login ID number to include a 9).

When one or more players arrive at the table to play, the dealer presses the appropriate number button and the input device 11 signals to the table computer 13 that that number of players are present. In the example shown, the memory 16 in FIG. 1A records at 16b that the dealer indicated at 08:46 that no players were present, and at 16c records that the dealer subsequently indicated at 08:49 that two players had arrived at the table to play. When the dealer pressed the “2” button on the touch-screen, this screen moved to the configuration shown in FIG. 2C. The number 2 button changes colour to confirm to the dealer that this is the currently indicated number of players, the “0” button reverts to its original colour and the “First Bet” button changes colour (or appearance, possibly by flashing) to indicate that this is the next expected input from the dealer. The table computer stores data indicating the number of players present and the time when the dealer indicated that that number of players are present. As players arrive and leave, the dealer presses the appropriate number button to show how many players are present, and the table computer records the time of each change in the number of players.

When a number of players has arrived and been indicated via the dealer input device 11, the dealer invites the players to place their wagers by placing chips or cash in one of the three betting fields corresponding to their player position. In example seen in FIG. 1, the player at position number 5 has placed chips 20 in the betting field in his player position corresponding to the result “player”, and the player at position number 10 has placed banknotes 21 in his “Player” betting field similarly to indicate that his prediction of the game result will be that the “Player” hand will win.

When the first player to place a bet does so, the dealer touches the “First Bet” button on the screen of the input device 11 to indicate that betting has commenced. Again, the input device sends a signal to the table computer indicating the first bet of the game has been placed, and the processor 14 of the table computer 13 then retrieves the current time from the clock means 15, adds a timestamp to the signal and stores the signal in memory to record the time at which the first bet was placed. In the example shown in FIG. 1A, the processor 14 has stored in the memory 16 an entry 16d indicating that the “First bet” was placed at 08:55. Once again it is important to note that the dealer indicates that the first bet has been placed by a single press or touch of the dedicated “First bet” button, so as not to require significant extra work by the dealer.

The dealer then encourages any other players present to place their bets, and may register the placing of these further bets by pressing or touching an “additional bet” button either as each additional bet is placed, or by pressing or touching a number button to signify the total number of bets after all bets have been placed. Again, these signals are time stamped by the table computer and sent to server 18 for recording and analysis. An additional system, such as a CCTV surveillance system capturing an image of the betting fields, may provide data indicating the amount of a particular bet and/or the player who placed the bet by detecting the number and/or colour of the gaming chips or identifying currency placed on a betting field.

When all bets have been placed the dealer removes four cards face down from the dealing shoe 9 and places them in the regions 2a, 2b respectively of the dealing area to form the “Player” and “Banker” hands. As the first card is removed from the shoe 9, the detector 9d in the shoe registers the passage of the card, and the shoe 9 sends an output signal to the table computer 13 to indicate that the first card of the game has been dealt. The processor 14 of the table computer 13 again retrieves the current time from the clock means 15, adds a timestamp to the signal and stores the signal in memory. At this point in the proceedings, the dealer is fully occupied distributing the cards, but monitoring still takes place since an automatic detection of the cards is made and a signal is sent to the table computer by the dealing shoe. In the example shown in FIG. 1A, the processor 14 has stored in the memory 16 an entry 16e indicating that the “First card” was dealt at 08:57.

Once all the four cards have been dealt, the dealer, or one of the players, turns over the cards of the “Player” hand to show the card values. Turning of the cards may be notified to the table computer by the table operator touching a button on the input device 11, or may be detected by an additional system such as a video surveillance of the regions 2a and 2b of the dealing area, and a signal may then be sent to the table computer which timestamps the data and forward it to the server for recording and processing. The dealer applies the rules of the dealing tableau to add more cards as necessary in order to arrive at the final total for the “Player” hand.

The dealer, or one of the players, then turns over the “Banker” hand to show the card values, and the dealer applies the dealing tableau to arrive at the final total for the “Banker” hand.

Based on the final totals of the hands, the dealer then declares the result as a “Player” win, a “Banker” win or a “tie”.

If no player disputes this result, the dealer then collects the wagers of losing players, pays winnings to winning players, and the game ends. The dealer may signal the end of the game to the table computer via the dealer input device 11, for example by pressing or touching an “End game” button (not shown). In the illustrated example, a signal was received from the dealer input that the game ended, and a timestamp of 09:05 was added to the signal and the signal and timestamp were then stored in the memory 16 at 16f.

The processor may calculate the duration of the game by calculating the difference in time between the dealer pressing the “First bet” button and the dealer pressing the “End game” button, or may calculate the duration of the game by computing the difference in time between successive presses of the “End game” button.

Alternatively, the memory 16 may have stored in it, for each possible number of players at the table, a respective predetermined interval representing the typical interval from the dealing of the first card to the end of the game, i.e. the interval during which the cards are dealt, the dealing tableau applied, and the wagers settled. The processor 14 may calculate a duration for the game by adding this predetermined interval to the interval between the dealer pressing the “First bet” button and receipt of the “First card” indication, and may record the result in the memory 16 as the duration of the game.

In a further alternative, processor 14 may calculate the duration of a game by adding a predetermined interval to the time of the “First card” event, taking into account the number of players present at the table, and generate an “End game” entry for the memory 16 with a timestamp indicative of the calculated duration from the “First card” event.

If the outcome of the game is disputed, the dealer presses a “dispute” button on the input device, which signals the table computer that a result has been disputed and play is therefore suspended. The table computer records the time at which the dispute button was pressed. When the dispute has been resolved, the dealer presses the dispute button again to indicate that play can recommence, and the table computer again records the time at which the dispute button was pressed to recommence play. The “dispute” button may change its appearance after being pressed to indicate that a dispute is in progress, and to alert the dealer that it must be pressed again when the dispute is resolved. The “dispute” button may revert back to its original appearance when pressed again to indicate resolution of the dispute. Again, efficient operation is assured by having only a single button press by the dealer to respectively indicate the start and end of the dispute procedure.

It is from time to time necessary to replenish or reshuffle the cards C in the dealing shoe 9. This necessitates a suspension of play at the table. When a shuffle is required, the dealer presses the “Shuffle” button on the input device 11, and the table computer receives a “Shuffle” signal, applies a timestamp to the signal and stores it in memory 16. The “Shuffle” button may change colour or appearance to indicate that a shuffling event is in progress. FIG. 2D indicates the state of the display on the touch-screen when, during a game where the dealer has indicated that more than 11 players are present (the “11+” button is coloured), the colouring of the “Shuffle” button indicates that a shuffle event is taking place. The dealer then completes the shuffling process, either manually or automatically if an automatic card shuffler is being used. When the cards are reshuffled and ready for play, the dealer again presses the “Shuffle” button to signal that the shuffling period is ended. The “Shuffle” button returns to its default colour or appearance, and the table computer receives a second “Shuffle” signal, applies a timestamp to it and stores it in memory 16. In the example shown in FIG. 1A, the processor 14 has stored in the memory 16 an entry 16g indicating that the “Shuffle” button was pressed at 09:11 to signify the start of a shuffle event, has stored an entry 16h indicating that the “Shuffle” button was pressed again at 09:12 to signify the end of the shuffle event. As before, efficiency of operation is assured by having only a single button press by the dealer to respectively indicate the start and end of the shuffle procedure.

It is likewise from time to time necessary to replenish the dealer's supply of chips or cash, and this again necessitates a short suspension of play at the table while the dealer's attention is concentrated on handling the chips or cash. When a resupply or removal of chips is required, the dealer presses the “Credit/Fill” button on the input device 11 once and then attends to the required operation. When the dealer is again ready for play, the dealer presses the “Credit/Fill” button a second time to signal that the cash handling period is ended. The table computer receives the two “Credit/Fill” signals, applies timestamps to them and stores them in memory 16. As described above in relation to the “Shuffle” button, the “Credit/Fill” button may change its colour or appearance for the duration of the chip handling event. Efficiency of operation is again assured by having only a single button press by the dealer at each of the start and end of the chip handling procedure.

If a “touch-screen” input device is used, then pressing the “dispute” button, the “Shuffle” button or the “Credit/fill” button at the start of a these respective operations may change the appearance of the touch-screen so that the entire screen is taken up by the relevant button, signifying that the next input to the screen must be a second touch of the relevant button to mark the end of the interruption in play caused either by the dispute or by the need to shuffle.

FIG. 1D is a flowchart showing the operations required of the dealer to use the system of FIG. 1. After carrying out the “logon” step 100, the dealer determines whether there is a need either to shuffle the cards at step 101 or to manage his stock of chips at step 102, and if so the appropriate operation is carried out in steps 101a to 101c or steps 102a to 102c, respectively. If not, the dealer proceeds to step 103 determine whether the number of players at the table has changed since his last indication (or from the default indication of “0”), and if it has he enters the new number of players at step 104.

The dealer then awaits the placing of the first bet for the game, and enters “First bet” at step 105 when the first bet has been placed. When all bets have been placed, the dealer deals the cards at step 106, and at step 107 applies the dealing tableau to determine the result of the hand, and then settles the players' wagers. In this embodiment, the dealer will then push an “End game” button on the input device 11 (step 108), to signal to the table computer 13 that the game has ended. The dealer then determines whether the result has been disputed and if so operates the “Dispute” button (step 109), resolves the dispute at step 110 and then again operates the “dispute” button (step 111) so that the times of the start and end of the dispute procedure are recorded in the table computer 13. If the result is not disputed, the process returns to the beginning and the dealer awaits the placing of the first bet for the next game.

At the end of the dealer's period of work at the Baccarat table, the dealer presses the “logout” button on the display screen, and a signal is again sent to the table computer indicating that the dealer is no longer responsible for this table. Operation of the table is then suspended until a new dealer logs in. The display screen may, when the dealer logs out, show a display such as seen in FIG. 2H, to indicate to the departing dealer how long he has been at the table, how many games he has played, and a performance figure indicating whether or not this total of games exceeds the number of games expected to be played in that time. This information may be determined by the processor 14 of the table computer, with the duration of the dealer's shift being calculated from the time interval between the dealer's login and log out events, the number games being derived from the number of “First Bet” events or the number of “End game” events recorded, and the performance figure being determined by comparing the number of games actually played with the number of games expected within a particular playing period.

The table computer 13 or the server 18 may store in memory an expected duration from the “First bet” to the “End game” event for each possible number of players at the table and may derive the performance figure by computing the available game playing time for each number of players, computing the number of games which should have been completed in that time, and comparing this with the actual number of games completed by the dealer during the session.

The available game playing time may be calculated by computing the length of time that the dealer was present at the table, and subtracting from it the total time taken up by shuffling, chip handling, disputes, and intervals when no players were present, and dividing this available game playing time into intervals corresponding to the number of players present at the table. For each of these intervals, the number of games expected to be completed is calculated based on the pre-stored information indicating the expected duration for a game with this number of players, and these numbers are added to give the total number of games which the dealer is expected to have completed during his session.

The processor may determine the actual number of games completed during the session by determining the total number of “End game” events or “First bet” events occurring during the session.

The dealer's performance figure may be arrived at by simply dividing the actual number of games completed by the number of games expected to be completed.

In the embodiment described above, the system for monitoring Baccarat table play comprises an input device operated by the dealer to notify a table computer 13 of events in the operation of the table, a dealing shoe including means for notifying the table computer of dealing events, and processing means in the table computer operable to store those notifications together with respective timestamp data to identify when each notification was received. In alternative embodiments, the functionality of the table computer 13 may be incorporated into the input device 11. In a further alternative embodiment, the dealing shoe 9 may include the input device 11 and the functionality of the table computer 13.

In the embodiment illustrated in FIG. 1, the table computer 13 is linked via a network 17 to a remote server 18. The server 18 comprises a processor 28 and a memory 38 storing programme routines for execution by the processor 28 to produce performance reports on the basis of the timestamped data collected from the Baccarat table. Although in FIG. 1 only one table computer 13 and one gaming table 2 are shown, it is to be understood that a plurality of gaming tables 2 may operate in the system, each having a respective dealing shoe 9 and input device 11 linked to a table computer 13 communicating to the server 18 via the network 17. Likewise it is to be understood that the functionality of the table computer 13 may be provided in the server 18, with the dealing shoe 9 and input device 11 of each baccarat table 2 communicating via the network 17 with the server 18 to record and timestamp events in a memory in the server 18.

Examples of the reports are illustrated in FIGS. 3A to 3E. In FIG. 3A, a report showing the average number of games played by each dealer per hour of playing time is illustrated. To compile this report, the processor 28 of server 18 retrieves from the memory 16 data relating to each of the dealers who have logged on to the table, and processor 28 calculates the time interval between the dealer's logon and log off times to arrive at the total time the dealer spent at the table. The processor then totals up any intervals of non-playing time, such as intervals when no players were present at the table, or intervals when shuffling or chip handling events or disputes were taking place. The non-playing time is then subtracted from the total time, to give a measure of the playing time available during that dealer's tenure at the table. The processor 28 then calculates the interval successive “End game” events to determine the duration of each game, and stores this information together with an indication for each game of how many players were present at the table at that time. In an alternative embodiment, the processor may calculate the duration of a game by calculating the interval between a “First bet” event and the subsequent “End game” event, and again may store the information together with an indication of the number of players present. Calculating the duration of the game in this way avoids false results, for example in the event that all players leave the table at the end of a game so that the interval between the last “end game” event and the next “end game” event will include a period during which no play is possible due to the absence of players.

The processor then groups together the games having the same number of players, and determines the average duration of those games, expressed in games per hour. The report shown in FIG. 3A presents, for each dealer, the average duration of games for each number of players. The right-hand column of FIG. 3A shows an overall average number of games per hour for each dealer, and the bottom row of the table shows the average game duration for all dealers of games having each number of players.

FIG. 3B is a report compiled by the processor showing the average time for each dealer between the end of one game (the “End game” event) and the subsequent “First bet” event. This calculation may be made by disregarding such intervals when no players are present at the table.

FIG. 3C is a report compiled by the processor showing the average time for each dealer between each “First bet” event and the subsequent “First card” event, providing an indication of the average time taken by each dealer to persuade the players to complete the betting process and deal the first card.

FIG. 3D is a report compiled by the processor showing the average time which each dealer spent with no players at his table. This report is compiled by taking, for each dealer, the total of the intervals between the dealer pressing the “0” button and the dealer subsequently pressing a number button, and finding the average length of these intervals for each dealer. This figure is a measure of how successful the dealer is in attracting players to his table.

FIG. 3E is a report compiled by the processor showing the average length of each non-playing interval correlated with the reason for the interruption in play. The processor compiles this report by finding the average duration for the intervals were no players are present, and finding the average time a shuffling interruption or a chip handling interruption or a dispute takes to complete, based on the recorded timestamp data indicating the start and end of each of these intervals.

The programming routine which is executed by the processor 28 to generate each of the report is stored in the memory 38 in the server 18. In the illustrated example in FIG. 1, reference number 39 indicates a programming routine stored in the memory 38 for generating one type of report “Report 1”, while 40 and 41 respectively indicate subroutines for generating other types of report “Report 2” and “Report 3”.

Each of the reports illustrated in FIGS. 3A to 3E may be displayed on the monitor of remote terminal 19, or may be produced as a printout or sent automatically in electronic form to a remote device by the server 18.

### ALTERNATIVE EMBODIMENTS

In the example described above, the dealer makes and input into his input device 11 to signify the number of players seated at the table 2. As an alternative to the dealer making such an input, the seats associated with the table may include means to transmit a signal to the table computer 13 in response to a person being seated on the chair. The signal will include identifying data to indicate which chair is in use, and the table computer 13 may include a register which records the identifying data of each chair associated with this table, so that the table computer 13 may determine how many players are seated at the table and in which chairs they are seated. Sensor devices such as pressure sensors in the chairs may be used to detect whether a person is seated on the chair. In one embodiment, each chair may include a sensor device, a transmitter, a control processor and a memory.

The transmitter is controlled by the control processor, using software stored in the memory, so that when the sensor device gives an output indicating that a person is seated on the chair, the control processor causes the transmitter to send a signal including an identifying code to identify the chair, and data indicating that the chair is occupied. This signal will be received by the table computer 13, timestamped and recorded in its memory 16 so that the processor 14 may determine which chairs are occupied and which are not.

The memory 16 of the table computer 13 may include as part of its start-up routine a polling of the chairs associated with the gaming table, and the memory may store a list of the identifying codes of the chairs associated with the gaming table. Signals received from chairs associated with other gaming tables may be compared with the stored list, and discarded if they identified in codes of the chairs do not match a chair on the list.

Preferably, the sensor device in each chair or the control processor in each chair causes the transmitter to send a signal only when the occupancy status of the chair changes, such as when a player 1st sits down or when the player gets off the chair.

The sensor devices each chair may be a force or displacement transducer, temperature sensor, optical sensor or any other suitable sensor for detecting the presence or absence of an occupant.

As an alternative to the use of a transmitter to send a signal wirelessly to the table computer, any other suitable transmission system may be used. In gaming tables where the seats are permanently fixed adjacent the table, the sensor devices may be connected to the table computer 13 by a hard-wired connection such as a LAN cable.

If the dealing shoe 9 is of a type which can automatically perform shuffling operations on command by the dealer, the shoe may be arranged such that when the dealer operates an input on the shoe to commence a shuffling operation, the shoe will then send a signal to the table computer indicating the start of a shuffle. The shoe may also send a further signal to the table computer when the shuffling operation is completed and the shoe is again ready for play.

In some commercially-available dealing shoes, such as the “Angel Eye” shoe, a card reader is positioned at the discharge chute and reads the value of each card dealt, so that the dealing shoe can determine the correct result for each game and provide an output, usually by means of a an indicator light, showing the correct result of the game. It is foreseen that such a shoe may be used in the system of the present invention, to provide an output which will assist in the resolution of disputes. The dealing shoe may also provide some processing capability, and may provide an output indicating the number of games played since logon, so that the processor in the table computer does not have to compute this figure but can simply receive it from the shoe.

In an alternative embodiment, the display device 11 may include a “First card” button which the dealer can press to indicate that the first card has been dealt, so that the display device 11 may be used with a dealing shoe having no card detector or output device. However, in order to make this as ergonomically efficient as possible, the input device should be positioned adjacent the dealing shoe. Alternatively, the dealing shoe 9 may be provided with a conveniently-placed input at button 9b for the dealer to press as he removes the first card from the shoe in order to send a “First card” signal from the shoe 9 to the table computer 13. Again it is important to note that a dedicated “First card” button pressed only once to indicate the start of the deal improves the efficiency of the game play, as the dealer's time is not taken unnecessarily to perform a complicated data input procedure.

The input device 11 in the described embodiment is provided with individual control buttons corresponding to “Shuffle”, “Credit/Fill” and “Dispute” which have a toggling action, i.e. the button is pressed or touched once to signify the start of an event, and pressed again to signify the end of that event. The appearance of the button on the touch-screen may change, for example from a default configuration of “Start Shuffle” to a configuration showing “End Shuffle” when the button is pressed, and may return to the default condition when the button is pressed again. As an alternative, the input device 11 may be provided with separate buttons for signifying the start and end of these events, i.e. a “Start Shuffle” button and an “End Shuffle” button, a “Start Credit/Fill” button and an “End Credit/Fill” button and a “Start Dispute” button and an “End Dispute” button.

The input device 11 may be a programmable portable device such as a mobile telephone, programmed to display the input control buttons on a touch-screen input, and to communicate with the table computer by a wireless connection. Alternatively the input device may be a portable processing device which is connectable to the table computer 13 by a cable, for example a USB cable.

The input device 11 may be a touch-screen device built into the table 2 so as to be in plain view of the players, or may be positioned and configured so as to be operable without the players seeing the device. In some embodiments of the invention, the playing area of the table 2 may be provided with sensors in the betting fields 6, 7 and 8 of each player to detect when a bet is placed, and provide a signal to the table computer 13 or server 18 that the “First bet” has been placed. Sensors may also be placed in the dealing areas 2a and 2b to detect the arrival of cards from the shoe, and may provide to the table computer 13 or to the server 18 the “First card” signal. Sensors in the betting fields 6, 7 and 8 may also be used to detect payment of winning bets by the dealer and collection of losing bets, and may send an “End game” signal to the table computer 13 or server 18 when all chips or cash have been cleared from the table, to signify the end of a game. Sensors may also be placed to detect the arrival and departure of players from the table, and may provide to the table computer 13 or server 18 signals indicating the presence or absence of a player at each player position. The table computer 13 or server 18 may compute the number of players present at any particular time on the basis of these signals.

As an alternative to sensors mounted in the playing area, the playing area may be imaged by an image capture device such as a CCTV camera, and image processing techniques may be used to detect the placing of bets, settlement of wagers, etc for example by detecting the presence or absence of gaming chips on the playing surface. The image capture device may also be used to record the cards in play, and to identify the cards and determine winning hands based on the identity and position of the cards on the gaming surface.

As an alternative to a touch-screen device, the dealer input device 11 may be a keypad having a plurality of physical buttons, each having one or more functionalities. The keypad may have a number of physical buttons corresponding to the number of possible events occurring during game play, so that the dealer only has to touch one of the buttons to send a signal signifying a particular game play event.

In the above-described exemplary embodiment, the invention is applied to monitoring the play of baccarat at a card table. The invention may equally be applied to monitoring other card games such as blackjack and poker.

### Blackjack and Poker

In the games of blackjack and poker, each individual player has his own hand and during each round of play has opportunities to interact with the dealer to change his hand by adding more cards, such as blackjack, or discarding and replacing cards as in poker.

When the invention is applied to monitoring the play of blackjack and poker, the significant information and timing of game events which are captured will include the number of players at the table, the start of each round of play, the completion of each respective player's hand, the completion of the dealer's hand, and the end of each game. Sensors may detect the presence of players on seats round the table and thus give an indication of the number of players present. A dealing shoe may be used, and the timing of the first card dealt may give an indication of the start of play. The table operator may be provided with an input device configured to have an input means corresponding to each game event which requires recording, and this may be a touch-screen device whose screen changes as each event is detected in order to configure the screen for the next likely input. The screen may be configured so as to present the table operator with as few input options as possible at each stage of the game, to reduce his workload.

The input device of the dealer may also serve as an output device to enable messages to be sent to the dealer without players becoming aware of them. For example, the data collected during play at the table may be analysed and used to present to the dealer and indication of table performance, such as how many games per hour are being played. The table operator may then vary his operating style in order to improve performance. Alternatively, analysis of data collected during play may be used to provide the table operator with information based on the analysis, for example an indication that one or more of the players at his table are reducing table efficiency by playing too slowly.

In another embodiment, data collected during play at the table may be analysed and compared with previously stored data relating to the table and optionally also to other tables in the same venue, and the processor may produce an output indicating changes to the tables at the venue, for example indicating that one or more tables at the venue should cease playing a particular game and play a different game, on the basis of this comparison. The changes may include alterations to the numbers of tables offering a particular game at the venue in order more efficiently to use resources to match the provision of a particular game to the demand from players for that game.

### Roulette

FIG. 4 illustrates a further embodiment of the monitoring system, applied to a roulette table. In the illustrated embodiment, the elements of the system which correspond to elements in the system shown in FIG. 1 are given like reference numbers. Present at the casino are a roulette table 2A, a roulette wheel 9A and a roulette betting grid 9B situated on the table, a dealer input device 11 also on the table 2A, and a table computer 13 to which the roulette wheel 9A, the betting grid 9B and the input device 11 are linked.

The roulette wheel 9A includes one or more sensor devices 9S to detect operations such as the launching of the ball around the rim of the roulette wheel, and conditions in the roulette wheel such as the speed and direction of rotation of the wheel, and/or when the ball has settled in one of the pockets of the wheel so as to give an indication balloon of the result of the spin.

The betting grid 9B includes a number of detectors 9D which sense the placing of chips on respective areas of the betting grid, to indicate wagers placed by players at the table. For clarity, only three detectors 9D are shown, but it will be understood that sufficient detectors will be provided to detect every possible bet which may be placed on the betting grid.

The input device 11 is similar to the device described in relation to the previous embodiment, and may be either a touchscreen device or an array of control buttons operable by the croupier to indicate events during each game. As before, if the input device 11 is a touchscreen device the screen may change during each game to present to the croupier only those inputs which are most likely to be needed next during the game.

Operation of the system in relation to the roulette table is similar to that described in relation to the card game, with the exception that the events during each game will be events relevant to a roulette game rather than to a card game.

In operation, the croupier will make an input to the device 11 to identify himself and to signify that the table is open for play. The detectors 9D then detect the first bet that has been placed on the betting grid, and send a signal to the table computer 13 which adds a timestamp to that signal and forwards it to the server at 18 for storage and later analysis. The detectors 9D may also detect subsequent bets placed on the grid, and send further signals to the table computer 13 which adds a timestamp to that signal and forwards it to the server at 18 for storage and later analysis. The detectors 9D may detect the placing of the bets, and an additional system, such as a CCTV surveillance system, may provide data indicating the amount of a particular bet and/or the player who placed the bet by detecting the number and/or colour of the gaming chips placed at that location on the betting grid.

When the croupier launches the ball into the rim of the roulette wheel 9A, this event is detected by the sensors 9S and again a signal is sent to the table computer, timestamped and forwarded to the server. The croupier may then make a further input to the device 11 when he announces to the players that no more bets are permitted, and again a signal is sent to the table computer indicating that the “No More Bets” event has occurred.

After a further interval, the ball drops from the rim of the roulette wheel and settles in a pocket in the wheel, where it is detected by the sensors 9S. A “Ball Settled” signal is sent to the table computer 13 at this point. This signal may also optionally identify the number of the pocket of the roulette wheel into which the ball has settled.

The croupier then resolves the wagers placed on the betting grid by the players, and the game ends as the croupier announces that the table is open for the next game and makes an appropriate input to the input device 11 to signify the start of the next game.

As described above in relation to the previous embodiment, the server 18 may analyse the time-stamped data received from the sensors 9S and 9D and the inputs made at the input device 11 by the croupier, and compile reports on the basis of the collected data to document the performance of the croupier and the table over a period of time.

In addition to the use of the system to monitor card games and roulette tables, the present invention may be applied to any gaming apparatus such as a craps table or other gaming system, by providing the table operator with an input device into which he can conveniently make inputs marking events during a game, coupled with sensors in the gaming table or a device associated with the gaming table to also provide inputs relating to events during gameplay.

The server 18 may include programs to enable the processor 28 to analyse data collected from various gaming tables in a gaming establishment, to detect trends in the collected data.

In one embodiment, the timestamped data concerning the numbers of players at each table may be processed to determine the number of players seated at active tables of a casino currently and at one or more previous times, and to compare the current number with previous numbers to detect whether the number of players is rising or falling. If the processor 28 detects that the number of players seated at active tables is rising, the processor 28 may send a signal to a remote terminal 19 associated with the casino management, to indicate that available capacity at the tables is reducing and more tables should be opened for play. Likewise, if the processor detects that the number of players seated at active tables is falling, then a signal may be sent to a management terminal 19 to indicate that tables should be closed to consolidate players onto fewer tables.

In embodiments where data is processed and a signal is sent back to the table operator (the dealer or croupier), the processor 28 may receive time stamped data concerning a particular game event and may determine an expected time interval until the next sequential event in that game. The processor 28 may then send a signal to the table operator's device 11 to display a countdown timer showing the remaining time until the next game in event is expected, so that the table operator may regulate the progress of play. The expected time interval may vary, depending on the number of players present at the table. If the table operator fails to maintain the expected schedule of game events, further instructions may be given to the table operator to improve his technique. Since a deviation from the expected schedule can be detected as it occurs, rather than from subsequent analysis of the stored data, instruction can be given to the table operator at an early stage to remedy the deficiency.

In some embodiments, the table operators input device 11 may include a screen which displays the sequence of events of a typical hand from start to finish, and indicates where in that sequence play currently stands. The display may also indicate to the dealer the expected interval remaining until the next game event, for example either by means of a numerical countdown or a graphical display such as a status bar which decreases in length to zero at the predicted next game event, or a dial gauge with an indicator needle which rotates down towards a 0 position as the remaining interval reduces. The display thus provides an indication to the table operator of the stage in the game which he has reached, and the remaining time available for him to reach the next stage in the game to remain on schedule.

In the above-described embodiments, the casino table operator uses table equipment such as a roulette wheel or a dealing shoe in order to progress the game. In these embodiments, an input device is placed so as to be accessible to the table operator's hand so that inputs marking game events may be made by the table operator. In a game where no table equipment is used, such as a card game where the table operator manually deals cards from a deck, the input device 11 may be a foot-operated device by means of which the table operator may input signals to signify game events to the table computer, preferably without the table operator's hands going out of view below the table.

In such an embodiment, the table operator will make inputs to his foot-operated device to mark each event in the game, for example by pressing one or more pedals or buttons mounted on a housing at floor level.

1. An apparatus, comprising:
a manual input device operable to provide output signals, the manual input device having a plurality of inputs each operable to provide a respective output signal corresponding to a respective event in a game being played at a gaming table;
a gaming device including at least one sensor to detect operations of or conditions in the gaming device during a game, and to provide an output signal;
a processor adapted to receive the signals from the manual input device and from the at least one sensor of the gaming device;
a clock to provide timestamp data to the processor; and
a memory;
wherein the processor is operable to:
receive the signals from the manual input device and from the at least one sensor of the gaming device;
add respective timestamp data to the signals received;
store in the memory the signals and their respective associated timestamp data; and
calculate, on the basis of the signals and their associated timestamp data, a time interval between the receipt of one signal and the receipt of a subsequent signal.

2. The apparatus of claim 1, wherein the gaming device is a dealing shoe, and the at least one sensor is operable to detect the dealing of a card from the dealing shoe and provide an output signal.

3. The apparatus of claim 2, wherein the manual input device and/or the dealing shoe are operable to provide signals to the processor indicative of:
i. a “logon” event signifying opening of the table for play by a dealer;
ii. identity data relating to the dealer;
iii. the start of a card shuffling operation;
iv. the end of a card shuffling operation;
v. the start of a chip replenishment and/or removal (credit/fill) operation;
vi. the end of a chip replenishment and/or removal (credit/fill) operation;
vii. the start of a dispute resolution period;
viii. the end of a dispute resolution period;
ix. a “First bet” event signifying the placing of a first wager;
x. a “First card” event signifying the dealing of the first card from the dealing shoe;
xi. an “End game” event signifying the completion of the game;
xii. the number of players present at the gaming table; and
xiii. a “logoff” event signifying the closing of the table for play.

4. The apparatus of claim 2, wherein the manual input device is operable to provide signals to the processor indicative of:
i. a “logon” event signifying opening of the table for play;
ii. identity data relating to the dealer;
iii. the start of a card shuffling operation;
iv. the end of a card shuffling operation;
v. the start of a chip replenishment and/or removal (credit/fill) operation;
vi. the end of a chip replenishment and/or removal (credit/fill) operation;
vii. the start of a dispute resolution period;
viii. the end of a dispute resolution period;
ix. a “First bet” event signifying the placing of a first wager;
x. a “First card” event signifying the dealing of the first card;
xi. the number of players present at the gaming table; and
xii. a “logoff” event signifying the closing of the table for play.

5. The apparatus of claim 1, wherein the gaming device is a roulette wheel including at least one ball sensor, and the manual input device and/or the ball sensor of the roulette wheel are operable to generate signals indicative of at least one of:
i. a “logon” event signifying opening of the table for play;
ii. identity data relating to the croupier;
iii. the start of a chip replenishment and/or removal (credit/fill) operation;
iv. the end of a chip replenishment and/or removal (credit/fill) operation;
v. the start of a dispute resolution period;
vi. the end of a dispute resolution period;
vii. a “First bet” event signifying the placing of a first wager in a game;
viii. a “No More Bets” event signifying the closing of betting in a game;
ix. a “Ball Launched” event signifying the launching of the ball on the roulette wheel rim;
x. an “Ball Settled” event signifying that the ball has settled in a pocket in the roulette wheel;
xi. a “Bets Resolved” event signifying that all wagers have been settled and a new game can begin;
xii. the number of players present at the playing table; and
xiii. a “logoff” event signifying the closing of the table for play.

6. The apparatus of claim 1, wherein the manual input device comprises a plurality of control input buttons, and wherein a single press of a control button causes a signal to be sent from the manual input device to the processor.

7. The apparatus of claim 6, wherein the gaming table has a number of player positions, and wherein the manual input device includes a respective control input button corresponding to each possible number of players that can be accommodated at the gaming table.

8. The apparatus of claim 6, wherein the manual input device includes a control input button for indicating the presence of 10 players, and a control input button to indicate the presence of 11 or more players.

9. The apparatus of claim 6, wherein the manual input device includes a control input button to cause a signal signifying the placing of a first wager to be sent from the manual input device to the processor.

10. The apparatus of claim 1, wherein the manual input device includes a control input button to cause a signal signifying the dealing of a first card to be sent from the manual input device to the processor.

11. The apparatus of claim 6, wherein the manual input device includes a control input button to cause a signal signifying the end of a game to be sent from the manual input device to the processor.

12. The apparatus of claim 6, wherein the manual input device includes respective control input buttons to cause a signal signifying the start of a shuffling event, a chip handling event and/or a dispute to be sent from the manual input device to the processor.

13. The apparatus of claim 12, wherein the control input buttons to cause a signal signifying the start of a shuffling event, a chip handling event and a dispute are also operable to cause a signal signifying the end of a shuffling event, a chip handling event and a dispute, respectively, be sent from the manual input device to the processor.

14. The apparatus of claim 1, wherein the processor is operable to calculate, on the basis of computed time intervals between received signals, the average number of games played per hour of playing time.

15. The apparatus of claim 1, wherein the processor is operable to calculate the interval between successive “End game” events to determine the duration of each game.

16. The apparatus of claim 1, wherein the processor is operable to calculate the interval between each “First bet” event and its subsequent “End game” event to determine the duration of each game.

17. The apparatus of claim 1, wherein the memory has stored in it a predetermined interval representing the typical interval from a “First card” event to an “End game” event, and wherein the processor is operable to calculate the duration of a game by adding this predetermined interval to the interval between a “First bet” event and a “First card” event of the game.

18. The apparatus of claim 17, wherein the memory stores a respective predetermined interval for each possible number of players.

19. The apparatus of claim 1, wherein the processor is operable to calculate, on the basis of computed time intervals between received signals, the average time for each dealer between each “End game” event and the subsequent “First bet” event.

20. The apparatus of claim 1, wherein the processor is operable to calculate, on the basis of computed time intervals between received signals, the average time between each “First bet” event and a subsequent “First card” event for a particular table operator.

21. The apparatus of claim 1, wherein the processor is operable to calculate, on the basis of computed time intervals between received signals, the average time interval with no players at the table.

22. The apparatus of claim 1, wherein the processor is operable to calculate, on the basis of computed time intervals between received signals, the average length of each non-playing interval.

23. The apparatus of claim 1, wherein the processor is operable to output the results of its calculations as a printout, by displaying them on a monitor, or by sending them automatically in electronic form to a remote device.

24. A method, comprising:
generating, by a processor, signals at a gaming device and/or a dealer input device to indicate game events;
adding, by the processor, time information to the signals and storing the signals and their associated time information in a memory; and
calculating, by the processor, on the basis of the stored signals and their associated time information, a time interval between one signal and a subsequent signal.

25. The method of claim 24, wherein the gaming device is a card dealing shoe, and the dealer input device and/or the dealing shoe are operable to generate signals indicative of at least one of:
i. a “logon” event signifying opening of the table for play;
ii. identity data relating to the dealer;
iii. the start of a card shuffling operation;
iv. the end of a card shuffling operation;
v. the start of a chip replenishment and/or removal (credit/fill) operation;
vi. the end of a chip replenishment and/or removal (credit/fill) operation;
vii. the start of a dispute resolution period;
viii. the end of a dispute resolution period;
ix. a “First bet” event signifying the placing of a first wager in a game;
x. a “First card” event signifying the dealing of the first card in a game;
xi. an “End game” event signifying the completion of a game;
xii. the number of players present at the playing table; and
xiii. a “logoff” event signifying the closing of the table for play.

26. The method of claim 25, wherein the dealing shoe is operable to generate signals to indicate:
i. removal of a card from the dealing shoe; and/or
ii. the start of a card shuffling operation; and/or
iii. the end of a card shuffling operation.

27. The method of claim 24, further comprising calculating, by the processor, on the basis of computed time intervals between received signals, the average number of games played per hour of playing time.

28. The method of claim 24, further comprising calculating, by the processor, the interval between successive “End game” events to determine the duration of each game.

29. The method of claim 24, further comprising calculating, by the processor, the interval between each “First card” event and its subsequent “End game” event to determine the duration of each game.

30. The method of claim 24, further comprising:
retrieving, by the processor from a memory, data representing an interval from a “First card” event to an “End game” event; and
calculating, by the processor, the interval between the “First bet” event and the “First card” event of a game; and
calculating, by the processor, the duration of the game by adding the calculated interval to the retrieved interval.

31. The method of claim 30, wherein respective data representing the interval from a “First card” event to an “End game” event for each possible number of players is held in the memory, and wherein the processor determines how many players are present at the start of a game, and retrieves the corresponding interval data from the memory.

32. The method of claim 24, wherein the processor calculates the average time for each dealer between each “End game” event and a subsequent “First bet” event.

33. The method of claim 24, wherein the processor calculates the average time for each dealer between each “First bet” event and a subsequent “First card” event.

34. The method of claim 24, wherein the processor calculates the average time which each dealer spent with no players at the table.

35. The method of claim 24, wherein the processor calculates the average length of each non-playing interval.

36. The method of claim 24, wherein the processor outputs the results of its calculations as a printout, by displaying them on a monitor, or by sending them automatically in electronic form to a remote device.

37. The method of claim 24, wherein the gaming device is a roulette wheel including at least one ball sensor, and the dealer input device and/or the ball sensor of the dealing shoe are operable to generate signals indicative of at least one of:
i. a “logon” event signifying opening of the table for play;
ii. croupier identity data relating to the croupier;
iii. the start of a chip replenishment and/or removal (credit/fill) operation;
iv. the end of a chip replenishment and/or removal (credit/fill) operation;
v. the start of a dispute resolution period;
vi. the end of a dispute resolution period;
vii. a “First bet” event signifying the placing of a first wager in a game;
viii. a “No More Bets” event signifying the closing of betting in a game;
ix. a “Ball launched” event signifying the launching of the ball on the roulette wheel rim;
x. a “Ball settled” event signifying that the ball has settled in a pocket in the roulette wheel;
xi. the number of players present at the playing table; and
xii. a “logoff” event signifying the closing of the table for play.

38. An apparatus, comprising:
a manual input device operable to provide output signals, the manual input device having a plurality of inputs each operable to provide a respective output signal corresponding to a respective event in a game being played at the table;
a processor adapted to receive the signals from the manual input device;
a clock to provide timestamp data to the processor; and
a memory;
wherein the processor is operable to:
receive the signals from the manual input device;
add respective timestamp data to the signals received;
store in the memory the signals and their respective associated timestamp data; and
calculate, on the basis of the signals and their associated timestamp data, a time interval between the receipt of one signal and the receipt of a subsequent signal.

39. (canceled)

40. (canceled)
